(19) United States
(12) Patent Application Publication
(10) Pub. No.: US 2009/0013939 A1
(43) Pub. Date: Jan. 15, 2009

(54) APPARATUS AND METHOD FOR RESTRICTING MOVEMENT OF AN ANIMAL INTO OR OUT OF A DEFINED AREA

(75) Inventors: Joseph Santiago, Boca Raton, FL (US); Jose M. Fernandez, Boca Raton, FL (US)

Correspondence Address: HEAD, JOHNSON & KACHIGIAN, 228 W 17TH PLACE, TULSA, OK, 74119, US

(73) Assignee: WHITLOCK INTERNATIONAL, L.L.C., Boca Raton, FL (US)

(21) Appl. No.: 12/145,997

(22) Filed: Jun. 25, 2008

Related U.S. Application Data
(60) Provisional application No. 60/949,534, filed on Jul. 13, 2007.

(51) Int. Cl. A01K 15/04; A01K 15/02

(52) U.S. Cl. 119/719; 119/720

(57) ABSTRACT

An apparatus and method for restricting the movement of an animal into or out of a defined area for training and preventing the animal from crossing into or out of the defined area, e.g., a room within a house or an enclosed or defined space outside of a house, such as a gateway or a doorway, while not affecting surrounding areas. The apparatus and method for restricting the movement of the animal utilizes a receiving device shaped to decrease the peripheral reception an ultrasonic frequency emitted from a transmitter, and thereby decreasing the likelihood of corrective stimulation outside the defined area. The apparatus and method for restricting the movement of an animal also includes a variable duty cycle to achieve substantial power savings and prolonged battery life once the animal does not need continuous corrective stimulation.

### REFERENCE TO PENDING APPLICATIONS

This application claims the benefit of U.S. Provisional Application Ser. No. 60/949,534, filed on Jul. 3, 2007, which is incorporated herein by reference.

### BACKGROUND OF THE INVENTION

1. Field of the Invention

This invention relates generally to an apparatus and method for restricting the movement of an animal into or out of a defined area, and more particularly to an apparatus and method for restricting the movement of an animal for training and preventing the animal from crossing into or out of the defined area, e.g., a room within a house or an enclosed or defined space outside of a house, such as a gateway or a doorway.

2. Description of the Related Art

Electric and invisible fences are commonly used by pet owners to restrain a pet from leaving certain areas, such as a yard. Pet owners, however, are still commonly faced with the problem of attempting to restrict pets to specified areas within a house or other space. A common means for accomplishing this is the use of physical gates that are placed across doorways or other openings. While effective, such gates are very cumbersome and inconvenient for the pet owners who need to be able to easily enter or leave such spaces. Automatic gates are available, but they are also inconvenient as well as expensive to implement. Gates are also not visually appealing, especially inside a house.

Other known solutions make use of radio frequency transmitters and receivers that define variable range off-limit areas either within or outside of a house. While these products work well, they have a limitation in that they emit their radio frequency signals in an omni-directional, or circular way, and do not have the ability to restrict and direct signal output to a well defined line suitable for blocking just one doorway or gateway.

It is therefore desirable to provide an apparatus and method for restricting the movement of an animal for training and preventing the animal from crossing into or out of a defined area, e.g., a room within a house or an enclosed or defined space outside of a house, such as a gateway or a doorway.

It is further desirable to provide an apparatus and method for restricting the movement of an animal into or out of a defined area while not affecting surrounding areas.

It is still further desirable to provide an apparatus and method for restricting the movement of an animal that utilize a receiving device being shaped to decrease the peripheral reception of an ultrasonic frequency and thereby decreasing the likelihood of corrective stimulation outside the defined area.

It is yet further desirable to provide an apparatus and method for restricting the movement of an animal having a variable duty cycle to achieve substantial power savings and prolonged battery life once the animal does not require corrective stimulation as frequently.

### SUMMARY OF THE INVENTION

In general, in a first aspect, the invention relates to an apparatus for restricting the movement of an animal into or out of a defined area. The apparatus includes a transmitting device having transmitting circuitry for emitting compressional waves at ultrasonic frequencies. The transmitting device emits the compressional waves in a directional radiation pattern to delineate the boundaries of the defined area for restricting the movement of the animal. The apparatus also includes a receiving device having a power source and receiving circuitry for receipt of the compressional waves emitted from the transmitting device. The receiving device is shaped to decrease the peripheral reception of the compressional waves emitted from the transmitting device. The receiving device is capable of being harnessed to the animal and includes a corrective stimulation mechanism to apply to the animal corrective stimulation tending to restrict the movement of the animal into or out of the defined area.

The transmitting device may include an outer casing capable of being attached to a periphery of the defined area near ground level. The defined area may be a doorway or a gateway. Moreover, the transmitting device can include a microcontroller for controlling a transducer, from which the compressional waves are emitted. The compressional waves may be emitted from the transducer of the transmitting device at approximately 15 degree angles.

The receiving device of the apparatus may be modular and may include an outer casing having protuberances at each opposing end. The outer casing may be bone shaped. Moreover, the receiving device can include a microcontroller for controlling a transducer, from which the compressional waves emitted from the transmitting device are received. The transducer of the receiving device may be a plurality of transducers. In addition, the receiving device may be harnessed to a collar to be worn by the animal.

The receiving device of the apparatus may also include a variable duty cycle for power savings and prolonged power source life once the animal is sufficiently trained. The variable duty cycle can includes a standard battery life mode and an extended battery life mode, wherein the extended battery life mode is activated in response to predetermined criteria programmed into the microcontroller of the receiving device. The predetermined criteria programmed into the microcontroller of the receiving device may be a shock count algorithm for determining when the animal is sufficiently trained.

In general, in a second aspect, the invention relates to a method for restricting the movement of an animal into or out of a defined area. The method includes the steps of emitting compressional waves at ultrasonic frequencies from a transmitting device in a directional radiation pattern to delineate the boundaries of the defined area for restricting the movement of the animal. The compressional waves emitted from the transmitting device are received at a receiving device shaped to decrease the peripheral reception of the compressional waves emitted from the transmitting device. In response to receipt of the compressional waves emitted from the transmitting device and received at the receiving device, the receiving device applies corrective stimulation to the animal tending to restrict the movement of the animal into or out of the defined area. Once the animal is sufficiently trained, a power savings mode is activated having a variable duty cycle for power savings and prolonged power source life.

The defined area of the method for restricting movement of the animal may be a doorway or a gateway. Further, the receiving device may include a bone shaped outer casing having protuberances at each opposing end. Additionally, the variable duty cycle may include a standard battery life mode and an extended battery life mode, wherein the extended battery life mode is activated in response to predetermined criteria programmed into a microcontroller of the receiving device. The predetermined criteria programmed into the microcontroller of the receiving device can include a shock count algorithm for determining when the animal is sufficiently trained.

### BRIEF DESCRIPTION OF THE DRAWINGS

FIG. 1 is a top plan view of a doorway with an example of a transmitting device in accordance with an illustrative embodiment of an apparatus and method for restricting the movement of an animal disclosed herein;

FIG. 2 is an electrical schematic of an example of a circuit of the transmitting device in accordance with an illustrative embodiment of the apparatus and method for restricting the movement of an animal disclosed herein;

FIG. 3 is an electrical schematic of another example of a circuit of the transmitting device in accordance with an illustrative embodiment of the apparatus and method for restricting the movement of an animal disclosed herein;

FIG. 4 is a perspective view an example of a receiving device in accordance with an illustrative embodiment of the apparatus and method for restricting the movement of an animal disclosed herein;

FIG. 5 is a top plan view of an example of the receiving device in accordance with an illustrative embodiment of the apparatus and method for restricting the movement of an animal disclosed herein;

FIG. 6 is an electrical schematic of an example of a circuit of the receiving device in accordance with an illustrative embodiment of the apparatus and method for restricting the movement of an animal disclosed herein;

FIG. 7 is a flow chart of an example of a prolonged battery life algorithm in accordance with an illustrative embodiment of the transmitting device of the apparatus and method for restricting the movement of an animal disclosed herein; and

FIG. 8 is a flow chart of an example of a prolonged battery life algorithm in accordance with an illustrative embodiment of the receiving device of the apparatus and method for restricting the movement of an animal disclosed herein.

Other advantages and features will be apparent from the following description and from the claims.

### DETAILED DESCRIPTION OF THE PREFERRED EMBODIMENTS

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In accordance with one aspect of the invention, an apparatus and method is provided for restricting the movement of an animal into or out of a defined area for training, prevention and other purposes. The apparatus includes and the method utilizes a transmitting device 12 and a receiving device 14 for respectively emitting and receiving a sonic signal 16 to effectively delineate the defined area. The apparatus and method provided herein for restricting the movement of the animal into or out of the defined area has a particular application within a room of a house or an enclosed or defined area outside of a house, such as a gateway or a doorway. Although the apparatus and method provided herein is not limited to such an application, the apparatus and method will be described with such an environment and use.

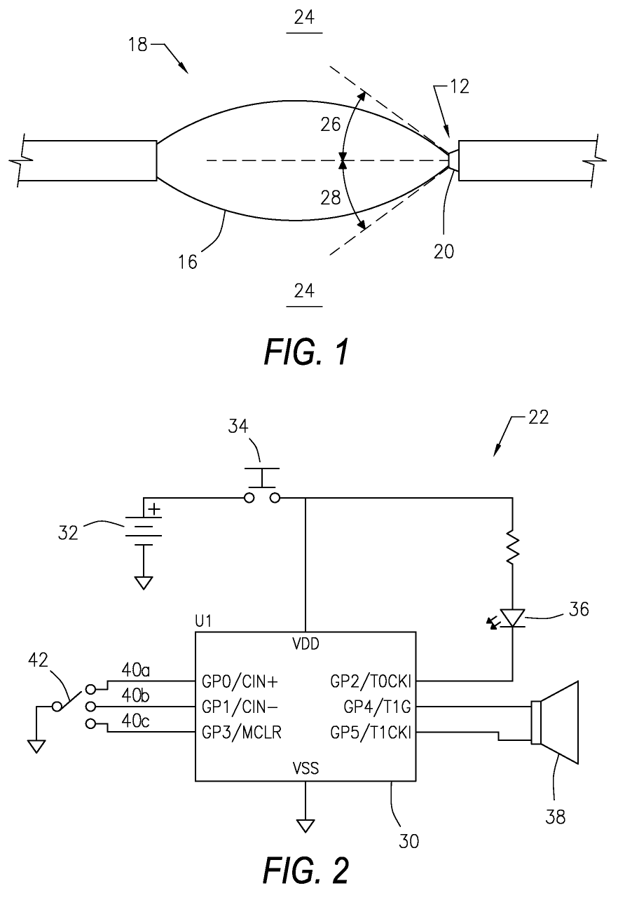

Referring now to the figures of the drawings, wherein like numerals of reference designate like elements throughout the several views, and initially to FIG. 1, which illustrates a plan view the transmitting device 12 of the apparatus and method for delineating the boundaries of the defined area. e.g., being affixed on one side of a doorway 18 at a certain distance from the ground. The transmitting device 12 includes an outer casing 20 to house the circuitry and components. All circuitry and power sources may be housed within the transmitting device 12, thus requiring no external connections. Further, the outer casing 20 of the transmitting device 12 may be a small plastic case capable of being affixed to the doorway 18 with double sided tape, hook and loop-type fasteners, or any other fastening mechanisms that provide for easy removal and relocation. However, fastening mechanisms that provide for more permanent installation may also be utilized.

The outer casing 20 of the transmitting device 12 contains circuitry and a transmitting transducer 22, such as an electromechanical or piezoelectric transducer, that emits a sonic signal 16 in the form of a compressional wave at an ultrasonic frequency, such as at 40 kHz. The sonic signal 16 emitted from the transmitting transducer 22 may have an adjustable range and be in highly directional radiation patterns, such that the sonic signal 16 is capable of being aimed across the doorway 18 to be controlled while not radiating into adjacent areas 24. The outer casing 20 of the transmitting device 12 may include an opening for the transmitting transducer 22 so that the sonic signal 16 is emitted from the transmitting transducer 22 without impedance from the transmitting device 12. In addition, the geometry of the transmitting transducer 22 may be such that the emitted sonic signal 16 exits the transmitting device 12 at an angle, for example approximately +/−15 degrees (shown as arrows 26 and 28). Given the fact that the range of the emitted sonic signal 16 is short, such as in the range of from two (2) to four (4) feet, the sonic signal 16 beam effectively defines a narrow barrier across the defined area, such as the doorway 18, without radiating into allowed adjacent areas 24 and falsely triggering a corrective stimulus from the receiving device 14.

The logic for producing the various patterns of sonic signal 16 emitted from the transmitting device 12 may be contained in a microcontroller 30 and implemented by software. By appropriate modifications to the software controlling the microcontroller 30 of the transmitting device 12, a multitude of wave forms and pulse patterns may be created so as to convey specific information to the receiving collar 14. The power source 32 for the transmitting device 12 is also housed within the outer casing 20 and may include an on/off switch 34. The power source 32 may be at least one battery, for example, a 3.2 volt lithium ion rechargeable battery or coin cell. Those skilled in the art will appreciate that other types of power sources or battery types may be utilized without straying from the spirit and scope of this disclosure. In addition, an indicator light 36, such as a light-emitting diode, may be implemented to provide user feedback.

Additionally, the transmitting device 12 may be software coded to periodically produce an audio signal, such as a 5.5 kHz pulse with a periodicity of 4 Hz, through a speaker 38 which can be heard by the animal prior to entering the defined area 18, and with proper training, should eliminate the need for the receiving device 14 to administer any corrective stimulus at all. Moreover, the pulse strength and/or periodicity of the audio signal may be modified to achieve the same overall results.

As shown in FIG. 2, the microcontroller 30 of the transmitting device 12 may be a PIC 12F629 8-pin microcontroller, although other microcontrollers may be used to accomplish the desired actions. Through this implementation, the transmitting device 12 supports three (3) output signals 40a, b and c that are selectable via multi-position switch 42. The sonic signal 16 emitted from the transmitting transducer 22 of the transmitting device 12 may be encoded in order to use the sonic signal 16 with additional information. This encoding of the sonic signal 16 may be accomplished through the use of various encoding methods similar to the use of amplitude-shift keying (“ASK”) modulation, familiar to those skilled in the art of radio frequency communication. This encoding may be easily implemented with the use of appropriate software in microcontrollers in both the receiving device 14 and transmitting device 12.

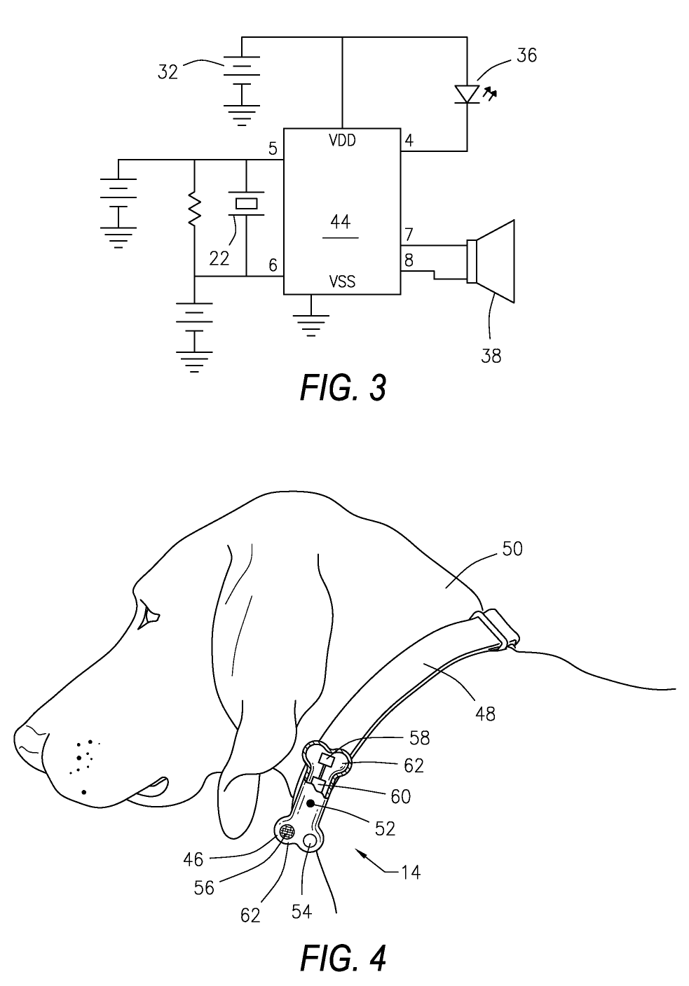

As shown in FIG. 3, the circuitry of the transmitting device 12 may be implemented through the use of an application-specific, integrated circuit 44, such as an Elexis 3V+3 chip. The integrated circuit 44 is capable of providing a single signal output to the transmitting transducer 22 as well as driving the indicator light 36 for user feedback. The integrated circuit 44 may be powered by the power source 32, for example, a 3.2 volt lithium-ion button cell, such as a 2032.

Turning now to FIG. 4, the apparatus includes and the method utilizes the receiving device 14 for receiving the sonic signal 16 emitted by the transmitting device 12. The receiving device 14 includes an outer casing 46 containing all circuitry and power sources necessary to receive the transmitted sonic signal 16 from the transmitting device 12 and react appropriately upon receiving the sonic signal 16. As fully discussed below, the receiving device 14 is equipped with at least one ultrasonic receiving transducer 58. The receiving transducer 58 may provide its input to a microcontroller 60 via suitable electrical components, such as amplifiers, band pass filters and an envelope detector. Upon receipt of the sonic signal 16, the receiver device 14, which may be under software control, determines whether or not the animal 50 has entered into the defined area 18 and administers the appropriate corrective stimulation, such as an audible alarm, electrical shock or otherwise.

The receiving device 14 may be equipped with a strap 48 that fits around the neck of an animal 50 in such a way that the receiving device 14 rests upon the underside of the neck of the animal 50. As shown in FIG. 4, the outer casing 46 of the receiving device 14 is parallelepiped and may include protuberances 62 on each longitudinally opposing end, i.e., a bone shape, to minimize weight, allow the geometry of the bone shape to receive the sonic signals 16 and accommodate a more ergonomic animal structure for at least one electrical probe (not shown) to provide one form of corrective stimulation. For instance, the receiving device 14 can be equipped with two electrical probes that contact the skin on the neck of the animal 50 and may administer various levels of shock to the animal 50 when triggered by the sonic signal 16 emitted by the transmitting device 12. It will be appreciated that the receiving device 14 may be harnessed in other fashions, such as via an ankle band, in keeping with the spirit and scope of the apparatus and method disclosed herein. Further, user feedback may be provided on the receiving device 14 in the form of light-emitting diodes 52 that indicate an on or off condition, as well as battery charge status. The receiving device may also include a flat membrane switch 54 that allows a user to turn the receiving device 14 on or off, as well as select the level and type of corrective stimulation desired. Furthermore, the receiving device 14 may also include an audible mechanism 56 to emit an audio tone or tones via a piezo buzzer or any other type of suitable component that, once the animal 50 is trained sufficiently, may be sufficient to prevent the animal's entry into the defined area 18, without the use of electrical shock.

The outer casing 46 of the receiving device 14 may be parallelepiped and have the receiving transducer 58 recessed therein. However, the inclusion of protuberances 62 to the longitudinally opposed ends the parallelepiped receiving device 14, thus shaping the outer casing 46 like a bone, increases in directionality and creates an aesthetically pleasing appearance. The bone-shaped outer casing 46 provides increased functionality by decreasing the peripheral reception of the sonic signal 16, making the receiving device 14 more directional, and offering less chance for triggering outside the desired area 18.

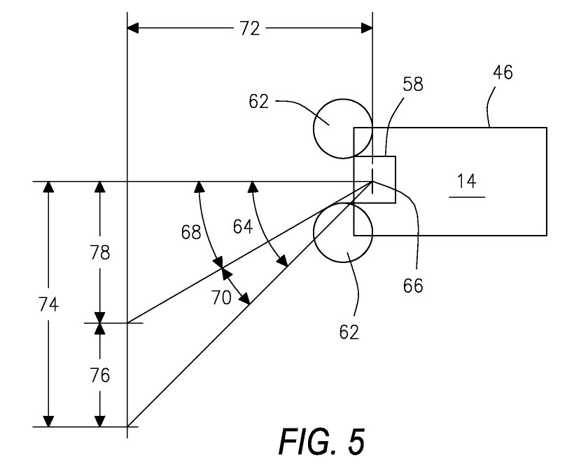

Referring now to FIG. 5, a receiving transducer 58 may be placed at each opposing end of the parallelepiped outer casing 46 of the receiving device 14. As an example, the angle of reception 64 of an incoming sonic signal 16 would be angle 68 plus angle 70, and in practice, which is typically approximately 45 degrees. For example, at a distance 72 of 36 inches, the width of an average doorway 18, from the receiving device 14, the distance 74 away from the axis 66 of the receiving device 14 that the sonic signal 16 could be received is 36 inches. That is, if the animal 50 were to approach the doorway 18 at the side of the doorway 18 opposite the transmitting device 12, the receiving device 14 would begin to trigger 36 inches before the animal 50 reached the doorway 18. Thus, the distance 74 equals distance 72 multiplied by the tangent of angle 68 plus angle 70. (Distance 74=distance 72*tan(angle 68+angle 70)=36 inches*tan(45 degrees)=36 inches).

By providing protuberances 62 at the opposing ends of the outer casing 46 of the receiving device 14, thus shaped like the ends of a bone, the triggering distance decreases by distance 76 from distance 74 to distance 78, or distance 72 multiplied by the tangent of angle 68. The angle of reception 64 may be decreased to angle 68 with the addition of protuberances 62, for example, angle 68 may be 30 degrees. In this example, distance 78 equals distance 72 multiplied by the tangent of angle 68. (Distance 78=distance 72*tan(angle 68)=36 inches*tan(30 degrees)=20.8 inches. Thus by providing protuberances 62 and shaping the outer casing 46 of the receiving device 14 like a bone, the distance to trigger at the far side of the doorway 18 is reduced from 36 inches to 20.8 inches, and improvement of 42.2% in directionality.

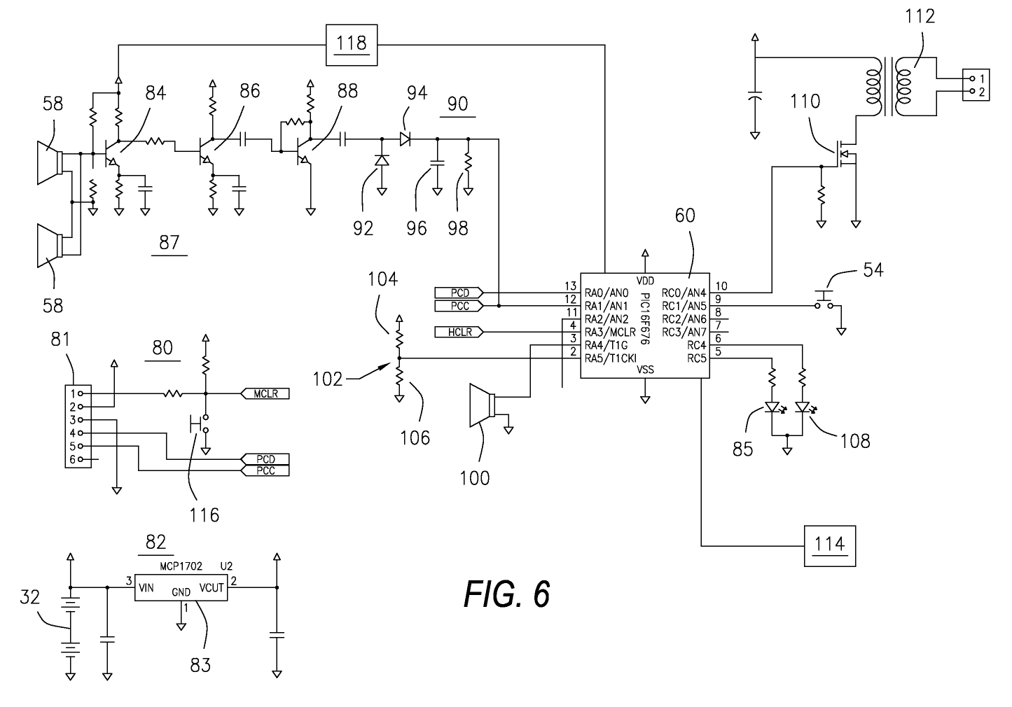

FIG. 6 is an electrical schematic of an example of the circuitry and components of the receiving device 14. The electrical schematic illustrated in FIG. 6 comprises the following functional units:

A charging circuit 80 may utilize a Microchip MCP73831 lithium ion charging controller 81. A charging port may be provided for an external wall charging transformer. The charging circuit 80 monitors power source 32 voltage and supplies charging current to the power source 32 in a constant current/constant voltage regime, such as to conform to lithium ion cell requirements. A status pin may be tied to a light-emitting diode 85 to indicate to the user that the power source 32 is being charged.

Voltage from the power source 32, e.g., a 3.6 volt lithium ion cell, may be regulated to 3.0 volts by a regulator circuit 82. A MCP1702 regulator chip 83 can be used by the regulator circuit 82. Regulated voltage is supplied to the microcontroller 60, as well as an amplifier circuit 87 and transducers 58.

An amplifier circuit 87 may include a three state amplifier fed by, for example, two ultrasonic transducers 58 in parallel. The transistors 84, 86 and 88, along with supporting discrete components, for the amplifier circuit 87 includes an amplifier and band-pass filter centered on 40 kHz. Following the amplifier circuit 87 may be an envelope detector 90, which may be made up of diode 92, diode 94, capacitor 96, and resistor 98, that converts the received 40 kHz pulses into a fluctuating direct current signal that varies from 0 to 2.5 volts and substantially replicates the envelope of the received sonic signal 16. Further, upon envelope detection, the sonic signal 16 may be fed into pin 12 of the microcontroller 60. The microcontroller 60 of the receiving device 14 may be a PIC16F676 microcontroller, however, any one of a number of suitable microcontrollers are available on the market and may be used.

Whenever the transmitted sonic signal 16 exceeds the threshold voltage of the comparator, which can be set internally to the microcontroller 60 via software, an interrupt is generated in the microcontroller 60, which then initiates verification of a valid sonic signal 16, as well as the appropriate corrective stimulus, if required. The software of the microcontroller 60 determines whether or not a valid sonic signal 16 is present by measuring the time between three consecutive received pulses. If the timing is correct, a valid sonic signal 16 is deemed to be present, otherwise the sonic signal 16 is considered to be noise. In addition, the microcontroller 60 may have a standard/extended battery life mode algorithm implemented in the software and controls the switch(s) to turn on/off the associated circuitry.

Audio output from the receiving device 14 may be achieved through software by the driving of a piezo buzzer 100 through pin 3 of the microcontroller 60, such as at 5.4 kHz. Depending on what shock level the receiving device 14 is set for, either one, two, or three auditory beeps will occur before a shock is delivered to the animal 50.

Battery status may be provided by monitoring the output of a low battery indicator voltage divider 102 having resistors 104 and 106, which may be read by an on-board analog-to-digital converter (“ADC”) on the microcontroller 60. When battery voltage falls below a predetermined voltage, a light-emitting diode 108 may flash red/green every five seconds.

In addition, a shocking output may be achieved by driving a transistor 110, such as a metal oxide semiconductor field effect transistor (“MOSFET”) transistor, through pin 10 of the microcontroller 60, such as at a frequency of 435 Hz and a duty cycle of 5 percent. This energizes the primary winding of transformer 112, which, at a turn ratio of 300:1, provides a shocking output of approximately 1,100 volts.

Furthermore, toggling the receiving device 14 on/off as well as selecting the stimulus level may be accomplished by repetitive closures of switch 54, such as a flat membrane switch accessible to the user. The switch 54 is capable of cycling through off, tone only, tone/low shock, tone/medium shock, and tone/high shock levels. In addition, a reset switch may be provided for complete reset in the event of a latching condition.

For use with cats, the high voltage shock correction stimulus may be replaced with a vibration stimulus created by a high speed eccentric cam motor 114, similar to those used in cell phones, or other vibrating devices. Of course, other suitable components may be used to achieve the same or similar results without straying from the scope of the present invention.

The receiving device 14 may also include a switch 116 in the power line that shuts down all power to the receiving device 14 upon turning it off. Alternatively, when the switch 116 is closed, the receiving device 14 does not completely turn off, but enters a power savings mode. In power savings mode, the receiving device may have power consumption in microamps, thereby providing for adequate battery life. To conserve power when in power savings mode, a transistor switch 118 may be provided to turn off the amplifier circuitry 87 or reduce the duty cycle.

Low power consumption may be achieved by allowing the receiving device 14 to enter power savings mode whenever a transmitted sonic signal 16 has not been received by the receiving device 14 for a given length of time. Receipt of a valid sonic signal 16 would power up the receiving device 14 and the sonic signal 16 is then decoded and acted upon. Again, the power source 32 for the receiving device 14 can include either replaceable lithium ion batteries or a rechargeable lithium ion cell that can be recharged via a charging port in the receiving device 14.

Moreover, the power savings mode may incorporate two extended battery life modes: a standard battery life mode and an extended battery life mode. The standard battery life mode may be accomplished by increasing the off period of the circuitry of the receiving device 14. For example, the off period may be increased by a factor of 2×, i.e. to approximately 150 ms. The extended battery life mode incorporates a secondary low power mode, which is activated once the animal is trained or requires less frequent corrective stimulation. The extended battery life mode can increase battery life almost indefinitely. For example, once the animal is adequately trained, the off period may be increased by a factor of approximately 5×, i.e. to approximately 500 ms.

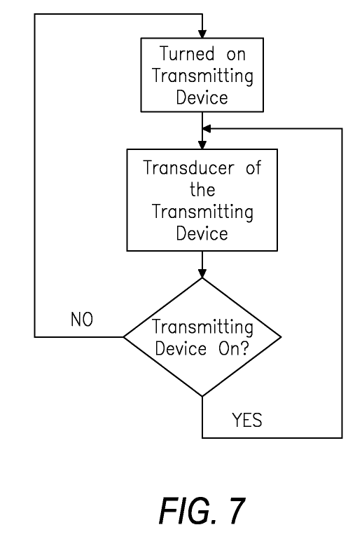

FIG. 7 illustrates an algorithm for the transmitting device 12, which may generate a 10 ms sonic signal 16 over a 50 ms period of time. Alternatively, the sonic signal 16 may be generated on a continuous bases; however, in keeping with the spirit and scope, one skilled in the art can envision other duty cycles.

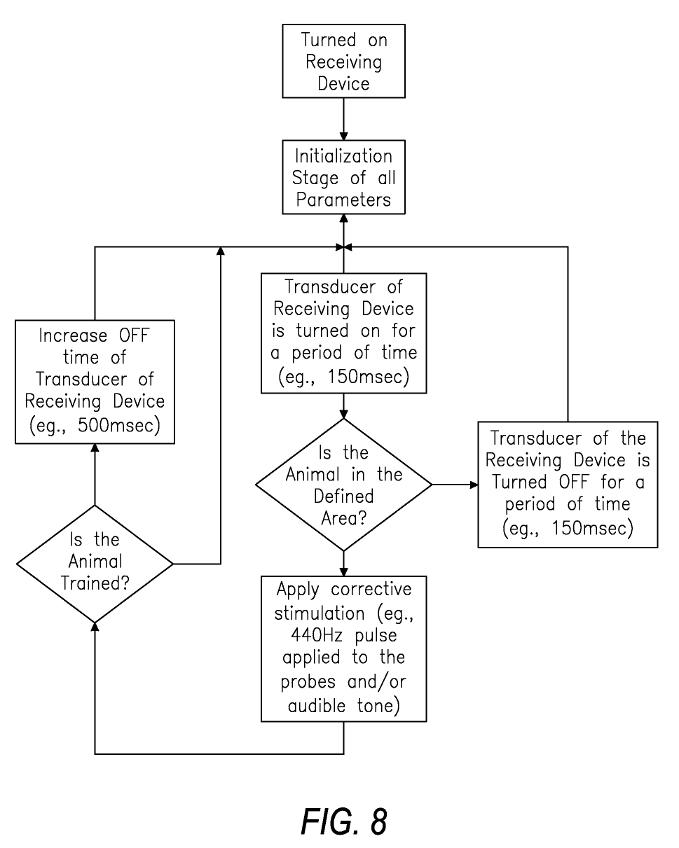

FIG. 8 illustrates an algorithm for the receiving device 14 incorporating the extended battery life mode feature for power savings. The algorithm may be implemented in software within the microcontroller 60 so as to count the number of corrective stimulus delivered to the animal in a given time period (“shock count”). When the frequency of corrective stimulations declines to a predetermined level or the shock count reaches a predetermined level, it can be assumed that the animal is trained to not approach the defined area. Since the animal is now unlikely to encroach the defined area, the receiving device 14 may enter the extended battery life mode by increasing the off time of the amplifier circuitry 87, or lessen the duty cycle. In order to disable or reset the extended battery life mode, the receiving device 14 should be turned on/off. This will reset the shock count to the default values. One skilled in the art can see that the extended battery life mode can be programmable to any desired value. By reducing the duty cycle of the receiving device 14, substantial power savings are achieved. This logic can be implemented so that the duty cycle is reduced in stages, eventually to the point were the receiving device is only turned on once every few seconds.

By making the receiving device 14 modular, the implementation of other functionality is possible. The receiving device may include a standard set of functions, such as tone and shock correction in response to receipt of a sonic signal. The receiving device can be modularized, so that the additional functions may be added separately as a snap-on module. In this way, an animal owner may upgrade to additional functionality when the need arises.

An additional module that may be implemented is voice capability. The use of voice audio may play a valuable role in the training of an animal by allowing the animal to respond to the actual voice of the owner. Voice capability may be accomplished through the use of a voice chip, such as a Sensory SVC-64m RSC-4128 or a Winbond ISD4003. A circuit using the voice chip would interface directly with the microcontroller 60, thus allowing the recording and playback of approximately 6 minutes of voice audio. Other voice chips, such as the Sensory RSC-4X series, may be utilized providing the ability to communicate via sonic signals, and thus allowing for a one-chip solution.

Another module may be the inclusion of the animal's identity information, as well as other pertinent data such as medical conditions, owner's phone and address, etc. The identity information can be recorded and stored in the receiving device, such as via a flash memory chip, for example micro-SD chips. If the animal is lost and found, the chip may be played back in any device that is designed to read the flash memory chip.

Another module that could be included with the receiving device is a circuit that monitors and records biometric information for the animal. Such information as heart rate, exercise levels, temperature, etc., can be recorded and that data uploaded into any computer equipped with software designed to read and analyze the data. In addition to the above, a small port may be integrated into the receiving device allowing the software on the microcontroller of the receiving device to be upgraded.

Whereas, the devices and methods have been described in relation to the drawings and claims, it should be understood that other and further modifications, apart from those shown or suggested herein, may be made within the spirit and scope of this invention.

What is claimed is:

1. An apparatus for restricting the movement of an animal into or out of a defined area, the apparatus comprising:
a transmitting device having transmitting circuitry for emitting compressional waves at ultrasonic frequencies, wherein the transmitting device emits the compressional waves in a directional radiation pattern to delineate the boundaries of the defined area for restricting the movement of the animal; and
a receiving device having a power source and receiving circuitry for receipt of the compressional waves emitted from the transmitting device, wherein the receiving device is shaped to decrease the peripheral reception of the compressional waves emitted from the transmitting device, wherein the receiving device is capable of being harnessed to the animal, and wherein the receiving device includes a corrective stimulation mechanism to apply to the animal corrective stimulation tending to restrict the movement of the animal into or out of the defined area.

2. The apparatus of claim 1 wherein the transmitting device includes an outer casing capable of being attached to a periphery of the defined area near ground level.

3. The apparatus of claim 1 wherein the defined area is a doorway or a gateway.

4. The apparatus of claim 1 wherein the transmitting device includes a microcontroller for controlling a transducer and wherein the compressional waves are emitted from the transducer of the transmitting device.

5. The apparatus of claim 4 wherein the compressional waves are emitted from the transducer of the transmitting device at approximately 15 degree angles.

6. The apparatus of claim 1 wherein the receiving device is modular.

7. The apparatus of claim 1 wherein the receiving device includes an outer casing having protuberances at each opposing end.

8. The apparatus of claim 7 wherein the outer casing is bone shaped.

9. The apparatus of claim 1 wherein the receiving device includes a microcontroller for controlling a transducer and wherein the compressional waves emitted from the transducer of the transmitting device are received by the transducer of the receiving device.

10. The apparatus of claim 9 wherein the transducer of the receiving device is a plurality of transducers.

11. The apparatus of claim 1 wherein the receiving device is harnessed to a collar to be worn by the animal.

12. The apparatus of claim 9 wherein the receiving device includes a variable duty cycle for power savings and prolonged power source life once the animal is sufficiently trained.

13. The apparatus of claim 12 wherein the variable duty cycle includes a standard battery life mode and an extended battery life mode.

14. The apparatus of claim 13 wherein the extended battery life mode is activated in response to predetermined criteria programmed into the microcontroller of the receiving device.

15. The apparatus of claim 14 wherein the predetermined criteria programmed into the microcontroller of the receiving device is a shock count algorithm for determining when the animal is sufficiently trained.

16. A method for restricting the movement of an animal into or out of a defined area, the method comprising the steps of:
emitting compressional waves at ultrasonic frequencies from a transmitting device in a directional radiation pattern to delineate the boundaries of the defined area for restricting the movement of the animal;
receiving the compressional waves emitted from the transmitting device at a receiving device shaped to decrease the peripheral reception of the compressional waves emitted from the transmitting device;
in response to receipt of the compressional waves emitted from the transmitting device and received at the receiving device, applying corrective stimulation to the animal tending to restrict the movement of the animal into or out of the defined area; and
activating a power savings mode having a variable duty cycle for power savings and prolonged power source life once the animal is sufficiently trained.

17. The method of claim 16 wherein the defined area is a doorway or a gateway.

18. The method of claim 16 wherein the receiving device includes a bone-shaped outer casing having protuberances at each opposing end.

19. The method of claim 16 wherein the variable duty cycle includes a standard battery life mode and an extended battery life mode; and wherein the extended battery life mode is activated in response to predetermined criteria programmed into a microcontroller of the receiving device.

20. The method of claim 20 wherein the predetermined criteria programmed into the microcontroller of the receiving device is a shock count algorithm for determining when the animal is sufficiently trained.
